(19) United States
(12) Patent Application Publication
(10) Pub. No.: US 2024/0389003 A1
(43) Pub. Date: Nov. 21, 2024

(54) METHOD FOR OPERATING A HEARING SYSTEM, HEARING SYSTEM, AND SOFTWARE PRODUCT

(71) Applicant: Sivantos Pte. Ltd., Singapore (SG)

(72) Inventors: Florian Högl, Erlangen (DE); Kristin Rohrseitz, Erlangen (DE)

(21) Appl. No.: 18/599,358

(22) Filed: Mar. 8, 2024

(30) Foreign Application Priority Data
May 15, 2023 (DE) 10 2023 204 530.3

(51) Int. Cl. H04W 48/16; H04R 25/00; H04W 48/18

(52) U.S. Cl. CPC H04W 48/16; H04R 25/554; H04W 48/18; H04R 2225/39; H04R 2225/55

(57) ABSTRACT

A method for operating a hearing system by way of a network having decentralized network nodes. The hearing system includes at least one hearing aid. The hearing system is connected via at least one decentralized network node to a data cloud, and data are exchanged between the hearing system and the data cloud.

### CROSS-REFERENCE TO RELATED APPLICATION

This application claims the priority, under 35 U.S.C. § 119, of German Patent Application DE 10 2023 204 530.3, filed May 15, 2023; the prior application is herewith incorporated by reference in its entirety.

### FIELD AND BACKGROUND OF THE INVENTION

The invention relates to a method for operating a hearing system by means of a network having decentralized network nodes. The invention furthermore relates to a hearing system and software on a data carrier and to the implementation of the method.

The terms hearing device or hearing aid are generally understood as an electronic device, which assists the hearing ability of a person wearing the hearing device (designated hereinafter as the “wearer” or “(hearing aid) user”). In particular, the invention relates to a hearing aid configured to compensate entirely or partially for a hearing loss of a hearing impaired user. Such a hearing aid is also designated as a “hearing aid device” (hearing aid, HA). In addition, there are hearing aids which protect or improve the hearing ability of users having normal hearing, for example, are to enable improved speech comprehension in complex hearing situations. Such devices are also designated as “personal sound amplification products” (acronym: PSAP). Finally, the term “hearing aid” in the sense used here also includes headphones worn on or in the ear (wired or wireless and with or without active interference noise suppression), headsets, etc., and implantable hearing aids, such as cochlear implants and devices for treatment or use with tinnitus.

Hearing aids in general and hearing aid devices especially are usually designed to be worn on the head and in particular here in or on an ear of the user, in particular as behind the ear devices (BTE) or in the ear devices (ITE). With respect to their internal structure, hearing aids generally have at least one output transducer, which converts an output audio signal supplied for the purpose of output into a signal perceptible as sound to the user, and outputs the latter to the user.

In most cases, the output transducer is designed as an electro-acoustic transducer, which converts the (electric) output audio signal into airborne sound, wherein the output airborne sound is emitted into the auditory canal of the user. With a hearing aid worn behind the ear, the output transducer, also designated as a “receiver,” is usually integrated outside the ear in a housing of the hearing aid. The sound output by the output transducer is conducted in this case by means of a sound tube into the auditory canal of the user. Alternatively thereto, the output transducer can also be arranged in the auditory canal, and thus outside the housing worn behind the ear. Such hearing aids are also designated as RIC devices according to the designation “receiver in channel”. Hearing aids worn in the ear, which are dimensioned so small that they do not protrude outward beyond the auditory canal, are also designated as CIC devices (i.e., the acronym for “completely in canal”).

In further structural forms, the output transducer can also be designed as an electromechanical transducer, which converts the output audio signal into structure-borne sound (vibrations), wherein this structure-borne sound is emitted, for example, into the skull bones of the user. Furthermore, there are implantable hearing aids, in particular cochlear implants, and hearing aids, the output transducer of which directly stimulates the auditory nerve of the user.

In addition to the output transducer, a hearing aid often has at least one (acousto-electric) input transducer. In operation of the hearing aid, the or each input transducer records airborne sound from the surroundings of the hearing aid and converts the airborne sound into an input audio signal (i.e., an electrical signal which transports information about the ambient sound). This input audio signal—also designated as a “recorded sound signal”—is regularly output in original or processed form to the user themselves, for example, for implementing a so-called transparency mode in a headphone, for active interference sound suppression, or—for example in a hearing aid device—for achieving improved sound perception of the user.

Moreover, a hearing aid often has a signal processing unit (signal processor). The or each input audio signal is processed (i.e., modified with respect to its sound information) in the signal processing unit. The signal processing unit outputs a correspondingly processed audio signal (also designated as an “output audio signal” or “modified sound signal”) at the output transducer and/or at an external device.

The term “hearing device” or “hearing system” designates a single device or group of devices and possibly nonphysical functional units which provide functions for the user together in operation. The hearing device can in the simplest case consist of a single hearing aid. Alternatively thereto, the hearing device can comprise two cooperating hearing aids for treating both ears of the user. In this case, this is referred to as a “binaural hearing system” or “binaural hearing aid”.

Hearing aids offer various additional (hearing/hearing aid) functions, for example, in the area of signal processing, which can improve a hearing utility for a hearing aid wearer (HAW). Examples of such functions could be: detecting one's own voice (Own Voice Detection, OVD), active interference noise suppression (Active Noise Reduction, ANR), active occlusion suppression (Active Occlusion Reduction, AOR); streaming of audio information (for example music), detecting different body signals (for example fitness), detecting certain events and reactions thereto (for example fault detection—if a user falls down, an alarm is sent), etc. Such functions are often embodied in this case as software or processing algorithms of the signal processing device.

Up to this point, the user has had to purchase a costly hearing aid to be able to use such functions. Alternatively, it is currently also possible that a user retrospectively purchases such functions for the use of their hearing aid, or subscribes to them for a specific period of time. The hearing aid functions are therefore sold as an optional and separate service. This is also designated as Hearing as a Service (HaaS). By way of such hearing as a service, it is possible for a user to select only those functions which they will also actually use. The user can thus select individually between different functions of the hearing aids. Such functions can be activated or subscribed to, for example, via a smart phone app of the hearing aid user.

For remotely managed hearing aids (hearing as a service) or noncontinuous services (such as functions on request or based on time-limited licenses) there is a need for options for “switching off” (shutting down, deactivating) and “restarting” (switching on, activating) hearing aids or individual functions remotely without a visit or another physical interaction of the hearing aid wearer with a health care professional (HCP) or an active use of a smart phone app. In particular, such shutdown and restart options are to be independent of the compliance of the hearing aid user, for example, to prevent fraud, inflexibility, or “ghosting” (i.e., not appearing at a scheduled appointment).

Furthermore, an interaction remotely and access independently of the hearing aid user is desirable if the hearing aid producer wishes to interact with the hearing aid, independently of whether the hearing aid user has installed the app or visits the health care professional.

This is desired, for example, for the following (usage) scenarios (use cases):
scenario “retirement home”: check using the smart phone of the care personnel (instead of using the smart phone of the respective resident) whether the hearing aids of the residents function perfectly (“mass check”), e.g., whether the hearing aids have enough power, function perfectly, optimize the equipment, exchange firmware (FW), set the TV streamer, . . . ;
scenario “broadcasting”: use a network to send important information to the hearing aid users in the surroundings;
scenario “search for hearing aids”: for example, in a retirement home place the smart phone at the entry of the laundry room and scan whether hearing aids are accidentally in the laundry room;
scenario “update time of day and date in the hearing aid”: Since hearing aids often do not have installed clocks, but only an approximate time determination, information about time of day and date could always be transmitted to the hearing aid when the hearing aid is in the vicinity of a smart phone;
scenario “read out data from the hearing aid”: Hearing aids only have a limited storage space, for example, for logged usage data. It would be advantageous if the logged data could be read out more often so that the hearing aid producer gets the logged data back faster and with better accuracy. Therefore, the hearing aid producer could, for example, read out the “health status of the battery” and remind the hearing aid user to acquire a new battery or carry out a “healing charge”. Other application: a helper reads out eHealth-related data from the hearing aid of a disabled/elderly person;
scenario “hearing aid subscription”: the hearing aid always receives the newest and best functions and updates;
scenario “mass FW exchange”: for example, during production or at the health care professional to update the firmware of multiple hearing aids at once;
scenario “find lost persons”: a person having a hearing aid gets lost and can be registered upon passing at an endpoint.

### SUMMARY OF THE INVENTION

The invention is based on the object of specifying a particularly suitable method for operating a hearing system. One object is to provide a simpler and more reliable remote access and change of the hearing aid status, independently of the compliance of the hearing aid user. The invention is furthermore based on the object of specifying a particularly suitable hearing system and particularly suitable software and a particularly suitable use of the method.

With the above and other objects in view there is provided, in accordance with the invention, a method for operating a hearing system via a network having at least one decentralized network node, the method comprising:
automatically starting a search for a decentralized network node of the network by the hearing system;
automatically connecting the hearing system to at least one decentralized network node of the network upon a successful search; and
automatically carrying out a data exchange between the hearing system and the at least one decentralized network node of the network.

Wherever the conjunction “and/or” is used in the following text, it is to be understood to mean that the features linked by way of the conjunction can be formed both jointly and as alternatives to one another. Similarly, the expression “at least one of A or B” is to be understood in the same way, namely, the feature A alone, or the feature B alone, or the combination A and B.

The method according to the invention is provided for operating a hearing system by means of a network having decentralized network nodes and is suitable and configured for this purpose. In other words, according to the method, a network having a number of decentralized network nodes is provided. The network thus has at least one decentralized network node. However, a large number of decentralized network nodes are preferably provided. The network preferably has a data cloud to which the decentralized network nodes are coupled or can be coupled.

A data cloud (computer cloud), also called cloud or cloud computing, is understood here and hereinafter in particular as a model which as needed—usually via the Internet and independently of devices—provides shared computer resources promptly and with little effort as a service, for example in the form of servers, data memories, or applications. Supply and usage of these computer resources is defined and generally takes place via a program interface or for users via a website or a program (for example an app).

The hearing system preferably has a hearing aid, in particular a hearing aid device (hearing aid, HA), which is wearable on or in an ear of the user (hearing system user). The hearing system or the hearing aid is provided and configured to establish a wireless signal connection to a network or decentralized network nodes, and to transmit and receive data via such a signal or communication connection.

According to the method, the hearing system starts a search for a decentralized network node automatically, thus without an action of a user. In other words, according to the method the hearing system automatically attempts to connect to the network. A search is ended, for example, automatically after a specified duration (for example 30 seconds), when no network or network node is detectable in the surroundings by the hearing system. The hearing system thus attempts to carry out a pairing process with a network or network node. In this case, for example, it is also conceivable that the network nodes actively search for a hearing system (for example a Bluetooth identifier).

When at least one decentralized network node of the network is found in the course of the search, the hearing system is automatically connected to the network or to the at least one network node (pairing). A (preferably encrypted) data exchange is then carried out between the hearing system and the network or the at least one network node.

A data exchange is understood in this case in particular as a bidirectional exchange of data, thus a bidirectional data transfer, between the hearing system and the network or the decentralized network node. However, unidirectional data transfers from the hearing system to the network (node) or vice versa are also possible.

In this case, the hearing system in particular transmits identification data (authentication data) to the network. “Identification data” are to be understood in this case in particular as data for identifying the (specific) hearing system, for example an identification number or a (digital) serial number. “Identification data” are furthermore also to be understood as situation-specific identifications (for example upon accessing a new network, for example in a railway station), which are also evaluated in consideration of (meta-)data from the data cloud of the network.

For example, it is conceivable that various identification groups are stored in the network or in the data cloud, wherein it is determined whether the identification data of the hearing system are assignable to an identification group, wherein data are transferred from the network (node) to the hearing system depending on the assignability.

For example, three types of identification groups are conceivable in this case: general, hearing system specific, and groups of hearing systems. “General” would include, for example, all hearing systems and hearing aids of one or more producer(s), for example, in the context of a security update or a warning message. The group “hearing system specific” would be, for example, specific for the individual device of the hearing system, thus, for example, an access or usage authorization for a HaaS function or a HaaS service of the hearing system. The “groups of hearing systems” would relate, for example, to all hearing systems having a specific hearing device platform/software, a certain design, or a certain brand.

The network or the network nodes transmit data to the hearing system depending on the identification data. For the data exchange or the data transfer between the decentralized network node and the hearing system it is conceivable, for example, that audio data are transferred from the network to the hearing system, for example for a catastrophe warning (such as “emergency—flood”). Furthermore, commands, thus control commands, can be transferred to the hearing system from the network (node) in order to control (activate, deactivate, . . . ) certain hearing system functions. The transferred data can also be data packets or binaries, for example in the context of a firmware update of the hearing system.

According to the method, the hearing system is connected via at least one decentralized network node, for example, to a data cloud of the network, wherein data can be exchanged between hearing system and the data cloud.

According to the invention, a network made up of decentralized network nodes (e.g., smart phones, router, etc., on which a network node app is installed) is provided, the decentralized endpoints of which are connected, for example, to a data cloud (cloud) and the hearing system. A decentralized network is thus used for the hearing system remote interaction and data transfer. The hearing system is preferably connected here to a large number of decentralized network nodes. These decentralized network nodes transfer data from the hearing system to the data cloud and vice versa. This enables simple “turning off” or “revival” of devices without an additionally installed clock or other data acquisition circuits within the hearing system, due to which time-linked and remote-controlled services (HaaS, location tracking, etc.) are possible.

With a sufficient capacity of the network, it is furthermore possible to transfer more data, so that other applications such as error and malfunction reports of the hearing aid, automatic exchange, or firmware updates can be implemented. Various profiles for services and data access via the remote network can be enabled in the data cloud, such as a caretaker mode (retirement home—readout status, LED & battery check, . . . ).

The method proceeds here from the consideration that modern operating and display devices, such as smart phones or tablet computers in particular, are widespread in current society and are therefore generally available and accessible at any time as decentralized network nodes. In particular, the user of the hearing system is always located with high probability in the vicinity of such a decentralized network node. According to the method, it is therefore also possible to construct a network for the remote access and the change of the hearing aid status in remote areas without HCP network or with poor Internet connection. The hearing system or the hearing aid therefore does not require an extra installed clock or other operations within the hearing aid, by which its efficiency is increased (optimization of storage space and size).

According to the invention, a network is constructed, which consists of various mobile endpoints (decentralized network nodes), for example smart phones on the market/in the world, which can establish an (in particular wireless) connection (Bluetooth, BLE-A, Wi-Fi, . . . ). These endpoints search automatically for hearing aids and establish a connection to them, in order to identify them on the basis of an identification stored in the hearing aid (hearing aid identification, HA-ID) and transmit data (such as commands for “switching off”/“reviving” hearing aids, reading out data, preventative maintenance).

For this purpose, for example, a reward program is possible for those who have opened corresponding network node apps on their smart phones and thus function as mobile endpoints. These mobile endpoints could even transmit their GPS position and further knowledge from the sensors (time, date, orientation, distance, . . . ) if a specific hearing system or hearing aid has been identified.

Apps (which can also run in the background of a third-party provider app such as Apple Health) are installed on the smart phones, which are connected to a database of the data cloud in which all identifications (IDs) and the status of the hearing system or hearing aid (for example, “turned off” or “not turned off”) are stored. The connection to the hearing aid preferably in this case has an authorization mechanism to enable modifications at the hearing aid (such as block chain, encryption) or to prevent unauthorized accesses and modifications.

In one advantageous embodiment, the connection is ended after the data exchange between hearing system and the at least one decentralized network node. In other words, the connection is in particular automatically disconnected so that the battery of the hearing system is not permanently loaded.

In one preferred embodiment, data from the data cloud of the network are stored on the at least one decentralized network node, wherein the data are transmitted to the hearing system in the course of the data exchange. In other words, a simultaneous connection of the hearing system to an endpoint and the data cloud is not necessary. For this purpose, the required information is preferably (temporarily) stored in the endpoint or the decentralized network node until the connection to the data cloud is reestablished (for example, off-line list of the “switched off” devices, which is stored in an arbitrary app).

Additionally or alternatively, stationary endpoints are also conceivable (such as laundry of a senior care home, see scenarios described at the outset; LoRa, or public network connection), to exchange data with hearing aids and localize the latter in the vicinity of this endpoint.

In an advantageous design, activation data are exchanged during the data exchange, wherein functions of the hearing system are activated or deactivated depending on the exchanged activation data. Activation data are to be understood in this case in particular as access, authorization, or license data with regard to a HaaS function of the hearing system, via which the HaaS function is released (switched on) or blocked (switched off).

In a suitable refinement, status data about a status are transferred from the hearing system to the at least one network node during the data exchange. “Status data” are to be understood in this case, for example, as information about a hearing system status or a status of a hearing system component. The status data are preferably collected from multiple hearing systems in the data cloud and evaluated jointly, wherein the data cloud transmits an action recommendation for the user via the decentralized network node to the hearing system on the basis of the evaluation. An “action recommendation” is to be understood in this case as a communication or message to the user.

The evaluation can be carried out, for example, by a cluster analysis.

The action recommendation can be transmitted, for example, as an acoustic message in the form of audio data to the hearing system and output to the user. It is also conceivable, for example, that a corresponding action recommendation is transmitted to a smart phone or a smart phone app of the user.

For example, a wearing duration of the hearing system is transmitted as status data, wherein a cleaning prompt is transmitted as an action recommendation depending on the wearing duration, for example, to clean the hearing system or the hearing aid, in particular a loudspeaker opening, of cerumen. For example, a status of a hearing system battery (such as State of Health, SOH) can also be transmitted, so that in case of a worsening battery status, for example, an exchange of the battery or the acquisition of a new hearing system can be generated as an action recommendation.

An additional or further aspect of the invention provides that the hearing system automatically repeats or restarts the search for a decentralized network node with a settable repetition frequency. After a successful or unsuccessful connection to a decentralized network node, a renewed search or a renewed connection attempt is thus automatically started after a settable period of time. It is thus ensured that the hearing system is reliably updated by the network. The hearing system thus does not search continuously for the network, but rather in a settable time interval, by which the energy reserves of the hearing system are preserved.

The repetition rate or the period of time until renewed triggering of a search can be set, for example, depends on a situation. Preferably, the repetition rate is set depending on a connection frequency (or data exchange frequency). In a preferred embodiment, a measure of the period of time since the last (successful) connection to a network node is determined by the hearing system during operation, wherein the repetition rate is set depending on this measure. The repetition rate is thus different shortly after a successful connection than if the last successful connection is already a long time ago. The repetition rate is thus dependent on how long ago a successful connection already took place. Preferably, the repetition rate is increased with increasing period of time since the last connection, so the hearing system attempts more frequently to connect itself to a network when the connection is already a long time ago.

Hearing systems, in particular hearing aids or hearing aid devices, generally do not have an integrated clock. To determine the measure, it is therefore possible, for example, that the hearing system counts how often a successful connection has been established since the hearing system was switched on. Additionally or alternatively, the measure can also be determined, for example, on the basis of a State of Charge (SOC) of a hearing system battery. For example, it is counted in this case how often a successful connection has been established between two specified states of charge (for example 100% and 50%).

In a further embodiment, the repetition rate is set depending on a wearing state. For example, the hearing system searches more frequently for the network or the decentralized network node when it is worn or used by the user. The hearing system is suitable and configured to determine the wearing state for this purpose.

For example, the wearing state is determined by means of a motion sensor. If the motion sensor detects physical movements of the user, this is classified as the wearing state “worn.” If physical movements do not occur for a longer time, for example, “not worn” is determined as the wearing state.

For example, physical movements can be detected by the hearing system in an EEG-based manner (electroencephalography), for example, in that electrodes are arranged on the surface of a hearing aid housing in order to detect the intention, planning, or execution of a physical movement on the basis of corresponding characteristic currents. A sound-based movement detection by means of the input transducers or microphones of the hearing system or hearing aid is also conceivable, for example, wherein noises originate from the joints or the clothing of the user and indicate movements. Such acoustic movement detections are known, for example, from the following patent applications and patents: CN 112656403 A, U.S. Pat. No. 10,062,373 B2, JP 5495415 B2, CN 112806981 B, U.S. Pat. No. 9,610,042 B1, AT 513434 B1, KR 101160227 B1, U.S. Pat. No. 11,417,307 B2, or US 2015/0038850 A1. Alternatively, for example, an EMG-based movement detection via an electromyography sensor is also possible, which is attached to the body of the user. Furthermore, an IMU-based detection by an acceleration sensor (gyroscope) of the hearing system is also possible, or by an inertial measuring unit which is worn on the body or on a piece of clothing or is fastened thereon (for example armbands or also IMU sensors).

It is conceivable in this case, for example, that when the motion sensor detects a fall of the user, aid is automatically requested via the network. For example, other users connected to the network are informed.

The hearing system according to the invention has at least one hearing aid in which an audio signal of ambient sound recorded by means of an input transducer is modified according to a large number of signal processing parameters in a signal processing unit to implement various (hearing aid) functions. The input transducer is in particular an acousto-electric transducer, in particular a microphone. The audio signal is an electrical signal which transports information about the recorded ambient sound.

The hearing aid of the hearing system is in the preferred application a hearing aid designed to treat the hearing impaired. In principle, however, the invention is also applicable to a hearing system having a “personal sound amplification device”. The hearing instrument is provided in particular in one of the structural forms mentioned at the outset, in particular as a BTE, RIC, ITE, or CIC device. The hearing instrument can furthermore also be an implantable or vibrotactile hearing aid.

The hearing system has a search unit for searching for a decentralized network node and a transceiver for signaling connection to a decentralized network node, and a controller (i.e., a control unit). The controller is generally configured in this case—by programming and/or circuitry—for carrying out the above-described method according to the invention. The controller is therefore specifically configured to start and carry out a search for a network or decentralized network node by means of the search unit and to establish a signal connection to the network via the transceiver in case of a successful search and to carry out a data exchange with the network node.

In one preferred embodiment, the controller is formed at least in the core by a microcontroller having a processor and a data memory, in which the functionality for carrying out the method according to the invention is implemented by programming in the form of operating software (firmware), so that the method—possibly in interaction with a device user—is automatically carried out upon execution of the operating software in the microcontroller. In the scope of the invention, however, the controller can alternatively also be formed by a non-programmable electronic component, such as an application-specific integrated circuit (ASIC) or by a FPGA (field programmable gate array), in which the functionality for carrying out the method according to the invention is implemented using circuitry means.

The hearing system comprises, for example, a remote interaction unit as a decentralized network node, which essentially carries out the above-described method on the network side. The remote interaction unit in the scope of the invention can be an electronic component, such as an ASIC, in which the functionality for carrying out the method is implemented in circuitry (hardwired). However, the remote interaction unit is preferably formed by a software unit (thus a computer program). The remote interaction unit can be integrated or implemented in a peripheral device detached from the hearing aid, for example in a smart phone or router. The remote interaction unit is preferably designed in the form of an app assigned to the hearing aid and interacting with the hearing aid, wherein the app is intended to be installed on a smart phone or other mobile device. The smart phone or mobile device is generally itself not a part of the hearing system in this case, but rather is only used thereby as an external resource.

The transceiver can be, for example, a radio frequency transceiver (e.g., LoRa, Bluetooth, WiFi, UWB, WLAN). Alternatively, the transceiver can be designed for transmitting inaudible acoustic signals (such as ultrasound). A transceiver for a signal transmission via magnetic induction (such as T-coil, . . . ) or via the mobile wireless network is also conceivable.

The hearing aid preferably has two transceivers, a long-range transceiver (such as Wi-Fi) and a short-range transceiver (for example for magnetic induction), wherein preferably a search for the network (node) is initially carried out using the short-range transceiver, and if this was negative or unsuccessful, a search is carried out using the long-range transceiver.

A device according to the invention for carrying out the method comprises a network having the data cloud and at least one decentralized network node, which can preferably be coupled automatically for signaling to a hearing system. The device or the network preferably has a controller in this case for carrying out the method. The device is, for example, implemented by an above-described hearing system and a remote interaction unit coupled thereto.

An additional or further aspect of the invention provides software on a medium or data carrier for carrying out or executing the above-described method. This means that the software is stored on a data carrier and is provided, and also suitable and designed, for carrying out the above-described method. Particularly suitable software for operating a hearing system is thus implemented, using which the functionality for carrying out the method according to the invention is implemented by programming. The software is therefore in particular operating software (firmware), wherein the data carrier is, for example, a data memory of the controller. The software of the hearing system is preferably divided into hearing aid-side software for the signal processing unit or the controller, and software for implementing a remote interaction unit (network side).

According to the use according to the invention, the above-described method is used for localizing the hearing system. This is advantageous in particular for the scenario “find lost persons” described at the outset. Preferably, the network or the data cloud logs the successful connections to the hearing system, in particular to which decentralized network node the hearing system was connected. The hearing system—and thus the user—can thus be located on the basis of the stored data or at least the probable occupied area can be restricted.

Other features which are considered as characteristic for the invention are set forth in the appended claims.

Although the invention is illustrated and described herein as embodied in a method for operating a hearing system, a hearing system, and related features, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a hearing system having a remote interaction unit; and

FIG. 2 is a flow chart and process schematic illustrating a method for operating the hearing system according to the invention.

Parts and dimensions corresponding to one another are always provided with the same reference signs throughout the figures.

### DETAILED DESCRIPTION OF THE INVENTION

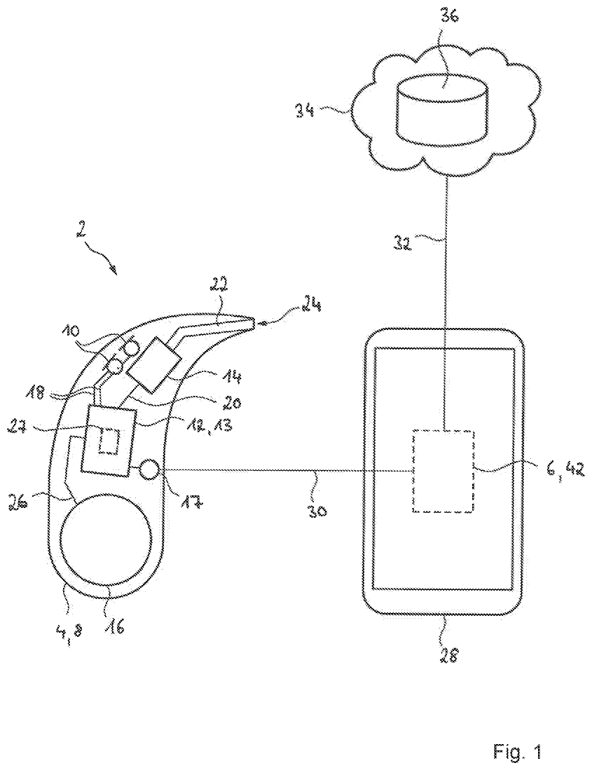

Referring now to the figures of the drawing in detail and first, in particular, to FIG. 1 thereof, there is shown a schematic and simplified representation of a hearing system 2, which comprises a hearing aid 4 and a remote interaction unit 6. The hearing aid 4 in this exemplary embodiment is a BTE hearing aid.

The hearing aid 4 comprises, for example, a (hearing aid) housing 8 to be worn behind the ear of a hearing-impaired user, in which as main components two input transducers 10 in the form of microphones, a signal processing unit 12 having a digital signal processor (for example in the form of an ASIC) and/or a microcontroller as a controller 13, an output transducer 14 in the form of a receiver, and a battery 16 are arranged. The hearing aid 4 furthermore comprises a transceiver 17 for the in particular wireless exchange of data, for example on the basis of the Bluetooth standard.

In operation of the hearing aid 4, ambient sound from the surroundings of the hearing aid 4 is recorded by means of the input transducer 10 and output as an audio signal 18 (i.e., as an electrical signal carrying the sound information) to the signal processing unit 12 (SPU). The audio signal 18 is processed by the signal processing unit 12. For this purpose, the signal processing unit 12 comprises a large number of signal processing functions, among other things an amplifier by which the audio signal 18 is amplified depending on frequency in order to compensate for the hearing impairment of the user.

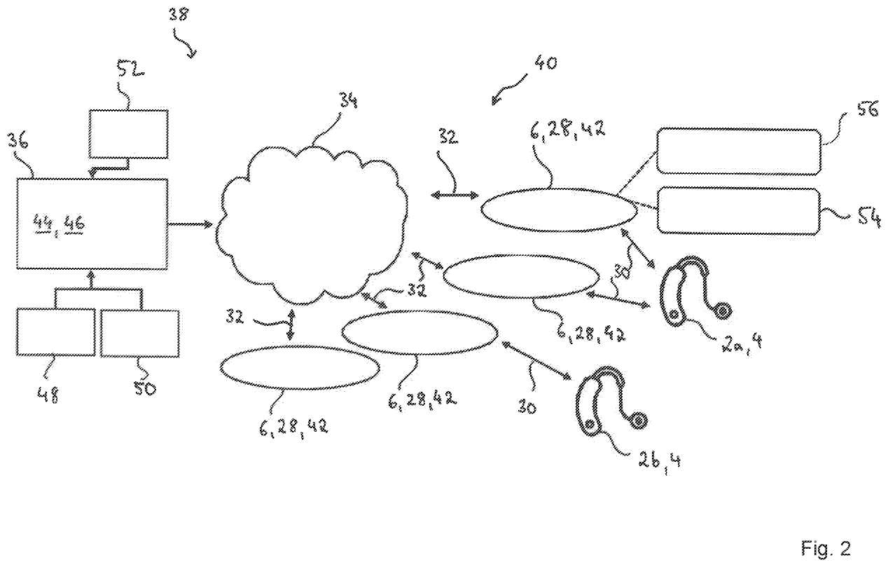

The signal processing unit 12 outputs a modified audio signal 20 resulting from this signal processing to the output transducer 14. The transducer 14 converts the modified audio signal 20 back into a sound. The sound, possibly modified in relation to the recorded ambient sound, is conducted from the output transducer 14 initially through a sound channel 22 at a tip 24 of the housing 8 and from there through a sound tube (see, e.g., FIG. 2) to an earpiece that is insertable or inserted into the ear of the user.

The signal processing unit 12 is supplied with electrical energy 26 from a battery 16.

A search unit 27 is integrated in the signal processing unit 12. The search unit 27 is implemented, for example, as software or firmware. The search unit 27 evaluates signals of the transceiver 17 in operation and searches (examines) as to whether a remote interaction unit 6 is located in the surroundings of the hearing aid 4.

The remote interaction unit 6 is implemented in the illustrated exemplary embodiment as software in the form of an app, which is installed on a smart phone 28. The smart phone 28 can in this case be a smart phone of the hearing aid user, however, the smart phone 28 can also belong to another person. The smart phone 28 is itself not a part of the hearing system 2 and is only used thereby as a resource. Specifically, the remote interaction unit 6 uses storage space and computing power of the smart phone 28 to carry out a method described in more detail hereinafter for operating the hearing system 2 or the hearing aid 4. Furthermore, the remote interaction unit 6 uses a Bluetooth transceiver (not shown in greater detail) of the smart phone 28 for wireless communication, i.e., for data exchange with the hearing aid 4 via a wireless signal or communication connection 30 (Bluetooth connection) indicated in FIG. 1 with the transceiver 17.

Furthermore, the remote interaction unit 6 is connected to a data cloud (cloud) 34 arranged in the Internet, in which a database 36 is installed, via a further wireless or wired data communication connection 32, for example based on the IEEE 802.11-Standard (WLAN) or a mobile wireless standard, such as LTE. The database 36 can also be a server coupled to the data cloud 34. For the data exchange with the database 36, the remote interaction unit 6 accesses a WLAN or mobile wireless interface (also not explicitly shown) of the smart phone 28.

A device 38 and a method for operating the hearing system 2 are explained in more detail hereinafter on the basis of FIG. 2.

The device 38 comprises a network 40 having the data cloud 34 and a number of decentralized network nodes 42 coupled thereto. The network nodes 42 are essentially formed in this case by a number of remote interaction units 6, which are thus formed as the data transmission interface to hearing systems 2.

The network nodes 42 or remote interaction units 6 are preferably installed as a network node app on smart phones, tablets, router, etc., wherein four smart phones 28 having remote interaction units 6 as the network nodes 42 are shown by way of example in FIG. 2.

The network 40 is provided and configured to connect automatically to a hearing system 2. A data connection is thus automatically established between the data cloud 34 and the signal processing unit 12.

The search unit 27 of the hearing system 2 starts a search for a decentralized network node 42 automatically at a settable repetition rate. In other words, the transceiver 17 is activated and attempts to connect the hearing system 2 to the network 40.

Upon a successful search, thus when at least one decentralized network node 42 of the network 40 is found in the surroundings of the hearing aid 4 in the course of the search, the hearing system 2 or the hearing aid 4 is automatically connected to the network 40. A (preferably encrypted) data exchange is then carried out automatically via the communication connection 30 between the hearing aid 4 and the network 40 or the at least one network node 42. After the data exchange, the communication connection 30 is preferably automatically ended by the hearing aid 4, for example by switching off the transceiver 17.

After a successful or unsuccessful connection to a decentralized network node 42, a renewed search or a renewed connection attempt is automatically started after a settable period of time. The repetition rate or the period of time until renewed triggering of a search can be set, for example, depending on a situation. The repetition rate is preferably set depending on a connection frequency (or data exchange frequency). For example, a measure of the period of time since the last (successful) connection to a network node 42 is determined by the hearing system 2 during operation, wherein the repetition rate is set depending on this measure. The repetition rate is preferably increased with increasing period of time since the last connection, the hearing system 2 thus attempts to connect itself more frequently to a network 40, when the last successful connection is already a long time ago.

The repetition rate for the search can also be set depending on a wearing state. For example, the hearing aid 4 searches more frequently for the network 40 or the decentralized network node 42 when it is worn or used by the user.

Multiple hearing systems 2 or hearing aids 4 can be connected in parallel to the network 40. In FIG. 2, for example, two hearing systems 2a, 2b or hearing aids 4 are connected to the data cloud 34.

Hearing aid identifications or identification data (ID-HA) 44 and a respective assigned hearing aid status or corresponding status data 46 are stored in the database 36. The hearing aid status or the status data 46 is in this case, for example, a HaaS status for a (hearing aid/signal processing) function implementable by the signal processing unit 12.

A wearing duration of the hearing aid 4 since the last cleaning can also be stored in the database 36 as status data 46, for example, wherein a cleaning prompt is transmitted as an action recommendation via the communication connection 32 to the endpoints 42 depending on the wearing duration.

Activation data 48 can also be part of the status data 46, which indicate, for example, whether a subscription for a HaaS function of the hearing aid 4 or the signal processing unit 12 is active (status “no kill”) or whether the subscription has expired (status “kill”).

In addition, for example, information or data 50 from a health care professional, thus, for example, the hearing aid settings or adaptations (fitting parameters), for the respective hearing aid 4 or the respective hearing aid user are stored in the database. The database 36 also has, for example, information or data 52 as to whether the hearing aid identification is assigned to a freely buyable or prescription-free hearing aid, thus a so-called OTC (over-the-counter) hearing aid.

The decentralized network 40 is used according to the method for a hearing aid remote interaction and data transfer. A hearing system 2 or hearing aid 4 is typically connected here after a successful search to at least one of the decentralized network nodes 42. These decentralized network nodes 42 transfer data from the respective hearing aid 4 to the data cloud 34 and vice versa.

This enables, for example, simple “switching off” (status “kill”) or “reviving” (status “no kill”) of HaaS functions without additional installed clock or other data acquisition circuits within the hearing aid 4, by which time-related and remote-controlled services (HaaS, location tracking, etc.) can be implemented easily and without compliance of the hearing aid user.

The endpoints or network nodes 42 also search automatically for hearing aids 4 and establish a connection to them, in order to identify them on the basis of the identification (HA-ID) stored in each hearing aid 4 and transmit data (such as commands to “switch off”/“revive” hearing aids, read out data, preventive maintenance).

In the exemplary embodiment of FIG. 2, two hearing systems 2a, 2b or hearing aids 4 are connected to a network 40. The first hearing aid 4 has, for example, the identification ID-HA3 and is connected to two network nodes 42, wherein the other hearing aid 4 has the identification ID-HA4 and is only connected to one network node 42. Upon a connection of the hearing aids 4 to the network 40, the respective identifications or information data are automatically transferred from the hearing aid 4 or hearing system 2a, 2b via the communication connections 30, 32 to the data cloud 34 and compared to the stored identification data 44.

The database 36 in this case has stored, for example, that the hearing aid 4 having the identification ID-HA3 has the hearing aid status “no-kill,” and that the hearing aid 4 having the identification ID-HA4 has the hearing aid status “kill.” The data cloud 34 thus transmits a corresponding release or switching-on command to the hearing aid 4 having the identification ID-HA3 (hearing system 2a) and withdraws a release from or transmits a switching-off command to the hearing aid 4 having the identification ID-HA4 (hearing system 2b). At least the connection 30 to the hearing aid 4 preferably in this case has an authorization mechanism (block chain and encryption).

In one preferred embodiment, the information of the database 36 is at least partially (temporarily) stored or storable in the remote interaction units 6 or network nodes 42 in order to also implement an activation of the hearing aids 4 in case of a temporary interruption of the communication connection 32. It is therefore not necessary for the communication connections 30 and 32 to exist simultaneously for the method. The data transfer or the data exchange via the communication connections 30 and 32 can also take place offset in time from one another.

For example, an off-line list 54 of the “switch-off” devices, which is stored in an arbitrary app, is saved in the network node 42. In other words, the off-line list 54 also comprises the activation data 48. During a data exchange by means of the communication connection 30—even without simultaneously active communication connection 32—HaaS functions of the hearing aid 4 can thus be activated or deactivated by means of the activation data 48 of the off-line list 54.

Furthermore, in the event of a communication connection 32 with the data cloud 34, information 56 can be stored in the network node 42. One conceivable item of information 56 in this case is, for example, a change of the fitting parameters which can be transferred to the hearing aid 4.

Furthermore, with a sufficient capacity of the network 40, it is possible to transfer more data, so that other applications such as error and malfunction reports of the hearing aid 4, automatic exchange, or firmware update can be implemented. Various profiles for services and data access via the remote network can also be enabled in the data cloud 34 for the hearing aids 4 or identifications, such as a caretaker mode (retirement home—read out status, LED & battery check, . . . ).

The claimed invention is not restricted to the above-described exemplary embodiments. Rather, other variants of the invention can also be derived therefrom by a person skilled in the art in the scope of the disclosed claims without departing from the subject matter of the claimed invention. In particular, all individual features described in conjunction with the various exemplary embodiments in the scope of the disclosed claims are furthermore also combinable in other ways without departing from the subject matter of the claimed invention.

The following is a summary list of reference numerals and the corresponding structure used in the above description of the invention:
2, 2a, 2b hearing system
4 hearing aid
6 remote interaction unit
8 housing
10 input transducer
12 signal processing unit
13 controller
14 output transducer
16 battery
17 transceiver
18 audio signal
20 audio signal
22 sound channel
24 tip
26 energy
27 search unit
28 smart phone
30 communication connection
32 communication connection
34 data cloud
36 database
38 device
40 network
42 network node
44 identification data
46 status data
48 activation data
50 data
52 data
54 off-line list
56 information

1. A method for operating a hearing system via a network having at least one decentralized network node, the method comprising:
automatically starting a search for a decentralized network node of the network by the hearing system;
automatically connecting the hearing system to at least one decentralized network node of the network upon a successful search; and
automatically carrying out a data exchange between the hearing system and the at least one decentralized network node of the network.

2. The method according to claim 1, which comprises terminating the connection between the hearing system and the at least one decentralized network node of the network after the data exchange has ended.

3. The method according to claim 1, wherein the network comprises a data cloud and the method further comprises: storing data from the data cloud on the at least one decentralized network node, and transmitting the data to the hearing system during the data exchange.

4. The method according to claim 1, which comprises, during the data exchange, exchanging activation data and selectively activating or deactivating functions of the hearing system in dependence on the exchanged activation data.

5. The method according to claim 1, which comprises, during the data exchange, transferring status data about a status of the hearing system from the hearing system to the at least one network node.

6. The method according to claim 1, wherein the hearing system is configured to automatically start the search for a decentralized network node with a settable repetition rate.

7. The method according to claim 6, which comprises, during an operation of the hearing system, determining a measure of a period of time since a last connection to a network node, and setting the repetition rate depending on the measure.

8. The method according to claim 6, which comprises setting the repetition rate in dependence on a wearing state of the hearing system.

9. A hearing system, comprising:
a hearing aid having a search unit configured to search for a decentralized network node, having a transceiver for a signaling connection to the decentralized network node, and having a controller for carrying out the method according to claim 1.

10. A software product, comprising non-transitory program code stored on a data carrier, the program code for carrying out the method according to claim 1 when the program code is executed on a computer.

11. A method for localizing a hearing system which comprises carrying out the method according to claim 1 for localizing the hearing system.
